(19) United States
(12) Patent Application Publication
(10) Pub. No.: US 2009/0207022 A1
(43) Pub. Date: Aug. 20, 2009

(54) RFID Asset Tracking Method and Apparatus

(75) Inventors: Maik Reckeweg, Kolitzheim (DE); Walter Poiger, Saale (DE); Wilhelm Wenzel, Sennfeld (DE)

Correspondence Address: JAECKLE, FLEISCHMANN & MUGEL, LLP, 12 Fountain Plaza, 8th Floor, Buffalo, NY, 14202-2922, US

(73) Assignee: M/A-Com, Inc., Lowell, MA (US)

(21) Appl. No.: 12/033,463

(22) Filed: Feb. 19, 2008

(51) Int. Cl. G08B 13/14

(52) U.S. Cl. 340/572.1

(57) ABSTRACT

A system and method for detecting the presence and precise location of a device bearing a radio frequency identification (RFID) tag comprising a plurality of resonators, a first circuit for driving the plurality of resonators with a low frequency drive signal for exciting nearby RFID tags via magnetic field excitation, a multiplexer having a plurality of input terminals, each input terminal coupled to one of the plurality of resonators, and an output terminal, and a signal processing circuit coupled to the output terminal of the multiplexer for reading the signals of the resonators and determining the identification of any RFID tags excited by the resonators.

### FIELD OF THE INVENTION

The invention pertains to the tracking of assets via RFID (Radio Frequency Identification) tags.

### BACKGROUND OF THE INVENTION

RFID (radio frequency identification) tags are increasingly being used to track assets in commercial applications. Specifically, they are used to track inventory in warehouses as well as on the shelves of stores. They also are being used to track the location of equipment in manufacturing facilities, offices, hospitals, and other commercial environments. Particularly, RFID tags are attached to goods or equipment and an interrogator unit is positioned in the vicinity of one or more RFID tags that can be used to detect them. Each RFID tag has a unique identification code that can be used to identify the good or equipment to which it is attached.

More specifically, RFID tags come in two types, namely, active and passive. Passive RFID tags are in more common use because they do not require a power supply. A passive RFID tag basically comprises a resonant circuit (an antenna or coil in combination with a capacitor), and a diode usually incorporated into an integrated circuit chip also containing a digital circuit that can output a particular ID signal by enabling or disabling the resonant circuit (commonly known as load variation).

The interrogator unit also comprises a resonant circuit. It also includes circuitry for driving the resonant circuit, for instance, with a fixed frequency signal. When the resonator of the interrogation unit is brought close enough to the resonator of an RFID tag, the resonator of the RFID tag draws some energy from the interrogation unit, which power-draw can be detected by suitable circuitry in the interrogation unit. The interrogation unit is equipped with a detection circuit that is able to detect even the smallest variations of the interrogator signal amplitude.

More particularly, the resonator on the interrogation unit radiates energy at a certain frequency determined by a built-in oscillator. If the RFID tag resonator is resonant at or close to that frequency, it will cause maximum current to flow in the RFID's resonant circuit. If the amount of current is sufficiently large, a sensitive rectifier diode on the RFID tag will generate a DC voltage which is used to charge a storage capacitor. When the capacitor reaches a sufficient charge, it turns on the digital circuit on the RFID tag, causing it to toggle a switch that enables or disables the resonator in a certain unique pattern (that unique pattern being its identification code). This in turn, causes the RFID tag to draw power from the interrogator unit in the same unique pattern dictated by the unique identification code programmed into the IC chip of that particular RF ID tag. Detection circuitry on the interrogator coupled to the resonator can detect the amplitude fluctuations and determine the identification code of the detected RFID tag.

The detection circuitry on the interrogator unit detects the power fluctuations on the resonator of the interrogator unit and sends that data to a digital processor, which determines the unique identification code of the RFID tag. Then, that data may be further processed as needed in the particular application. Merely as a very simple example, the identification code may be compared to a database of identification codes in order to identify the specific goods or equipment to which that particular RFID tag is attached and then that information may be logged into another database that discloses the locations within a warehouse complex where that good or equipment is stored.

Systems have been described in which RFID tags are used to identify electronic equipment contained in rack systems. For instance, many high technology companies have equipment rooms that may be used to house hundreds of electronic components in equipment racks. For instance, using an ISP (Internet Service Provider) as an example, an ISP may have rooms (known as data centers) that are filled with hundreds or even thousands of computer components, such as servers, that are located in hundreds of electronic equipment racks, each equipment rack holding scores of servers. If a piece of equipment fails and it is necessary to replace that piece quickly, it can be very difficult to locate the exact room, rack and slot within which that piece of equipment is located, if record keeping is not scrupulously maintained.

Accordingly, it is desirable to automatically track the presence and location of computer equipment in such environments.

U.S. Pat. No. 7,071,825 discloses a self-monitored active rack that uses RFID tags placed on equipment in conjunction with interrogation units built into the equipment racks for constantly monitoring the presence of equipment within the ranks.

However, at least one of the problems with systems of this nature is that they use antennas as resonators on the interrogation units which radiate energy over a large area in terms of distance as well as direction. Therefore, it is difficult to detect the position of an RFID tag (and the component to which it is attached) precisely. Particularly, a typical computer server rack system might have up to a maximum of 42 equipment slots, where each slot only about 2inches in height. Accordingly, an interrogation unit that activates RFID tags within 3-4 feet of the interrogation unit coil cannot possibly determine the exact slot in a rack of a particular piece of equipment. In fact, it may even be difficult to determine the exact rack in a densely packed data center.

It also is difficult to selectively activate a single RFID tag in environments where there are many RFID tags disposed very close to each other, such as in a data center. Accordingly, such systems may receive multiple RFID identification signals simultaneously. Special anti-collision processing often is used to distinguish IDs received simultaneously from multiple RFID tags. See the UHF RFID Class 1, Gen. 2 specification. Even so, it may be difficult to generate an accurate reading as to the RFID tags.

The aforementioned U.S. Pat. No. 7,071,825 mentions a system in which the interrogation units are mounted on the racks with multiple antennas, each for detecting a single piece of equipment. However, the system disclosed in that patent requires significant shielding of the antennas to prevent them from reading other nearby RFID tags on other nearby pieces of equipment. Furthermore, even with shielding, it is doubtful that the system described therein could avoid reading RFID tags on multiple adjacent pieces of equipment where the RFID tags are only a few inches apart from each other and, therefore, could not determine the exact slot within a rack of a given piece of equipment

### SUMMARY OF THE INVENTION

A system for precisely detecting the presence and location of RFID tags, for instance, the particular slot within which a piece of equipment bearing an RFID tag is positioned in an equipment rack. The system comprises a plurality of resonators, e.g., a coil and a capacitor, each coil corresponding to and disposed adjacent to a slot in the equipment rack, a first circuit for driving the plurality of resonators with a low frequency drive signal for exciting the RFID tags via a magnetic field radiated by each coil, a multiplexer having a plurality of input terminals, each input terminal coupled to one of the plurality of resonators, and an output terminal, and a signal processing circuit coupled to the output terminal of the multiplexer for reading the signals of the resonators and determining the presence and location of any RFID tags excited by the magnetic field of the coils.

The system may be modular and scalable. For instance, the system may comprise strips, each comprising a plurality of coils and a serial cascadable multiplexer coupled to determine the signals of the coils, and input and output connectors for coupling the strips in series to the signal processor circuit. Each strip may include a microcontroller for decoding the RFID identification codes on the coils. Furthermore, a conductor may run through each strip from the input connector to the output connector with a resistor therein, the conductor being connected out of the series coupled strips to a terminal of the microcontroller such that the microcontroller can determine the number of strips coupled together in series by detecting the resistance at that terminal.

### BRIEF DESCRIPTION OF THE DRAWINGS

FIG. 1 is pictorial representation of an intelligent rack system in accordance with the present invention.

FIG. 2 is a block diagram illustrating the components of an intelligent rack system in accordance with the present invention.

FIG. 3 is a block diagram of an intelligent rack system in accordance with the principles of the present invention illustrating the scalability of the system.

### DETAILED DESCRIPTION OF THE INVENTION

The present invention offers a system for automatically determining the presence and position of RFID tagged assets. The invention is particularly adapted, but not limited to, detecting the rack and particular slot within the rack of a piece of electronic equipment.

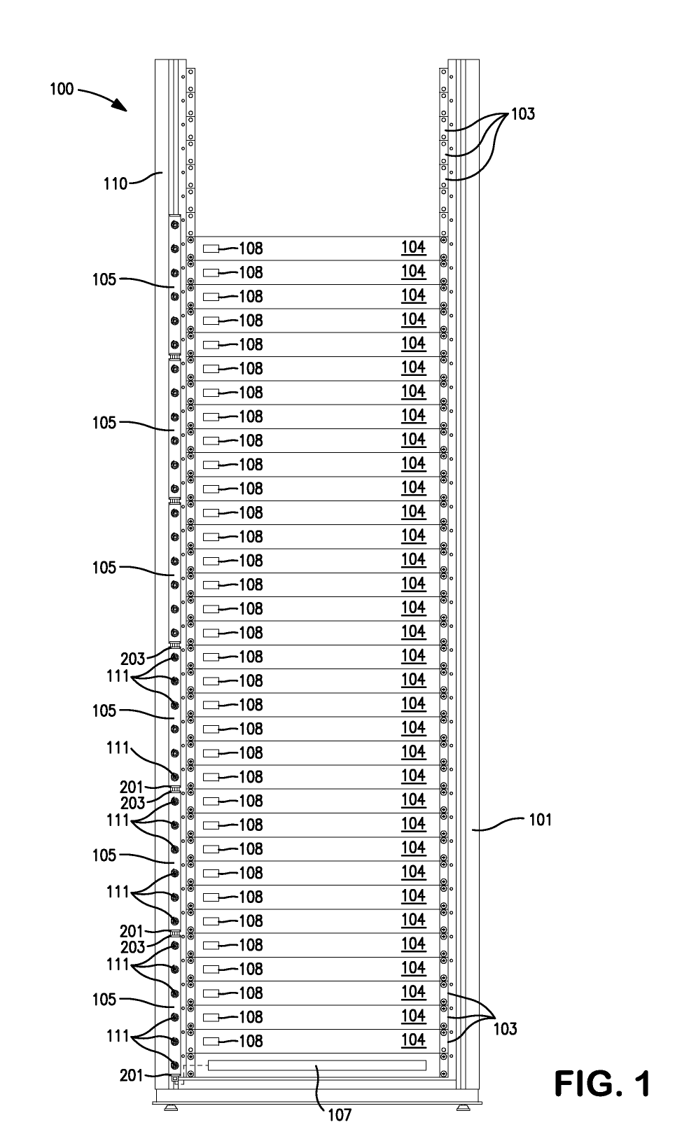

FIG. 1 illustrates the basic components of a system 100 in accordance with a first embodiment of the present invention used in connection with an equipment rack system. Particularly, a conventional computer or electronic equipment rack 101 defines a plurality of slots 103 into which electronic equipment modules 104 can be inserted. FIG. 1 illustrates one particular rack having 42 equipment slots. However, this is merely exemplary. In the illustrated embodiment, 35 of the slots are occupied by servers 104 and seven slots are empty.

The primary components of the present invention are one or more interrogator modules 105 shaped in the form of long narrow strips and a control box 107 containing circuitry, such as a microcontroller for operating the system. In one preferred embodiment of the invention, the control box 107 can be adapted to fit in one of the slots 103 of the equipment rack. In the illustrated embodiment, the bottom slot of the equipment rack differs from the 41 other slots of the rack in that it includes a faceplate with provision for three separate, smaller-sized equipment boxes. This is a common feature in some equipment racks, particularly “smart” racks, that already have a need to house a small piece of electronic equipment used by the rack itself. However, it should be understood, that, in other embodiments, the microcontroller may be located externally of the rack. The strips may communicate with the microcontroller via wired or wireless connection. In even further embodiments, the microcontroller may be embodied in one or more of the strips themselves.

Commercially available equipment racks for computer and other electronic equipment come in many different heights. Common heights include 4 and 8 feet. They also come in varying depths and widths particularly chosen for the type of equipment they are specifically designed to house. For instance, the illustrated rack 101 is what is commonly referred to as a 19 inch rack because the slots are about 19 inches wide. The slots are adapted to house servers or other computer equipment housed in standard enclosures that are 19 inches wide, about 2 inches tall, and typically about 19-22 inches deep. Thus, the rack is about 24 inches side overall, about 24 inches deep. The rack is about 8 feet tall.

In accordance with the invention, each piece of electronic equipment 104 that will be housed in one of the racks 101 bears an RFID tag 108. In the illustrated embodiment, the RFID tag 108 is attached to the front panel of the piece of equipment near the left edge. This is merely exemplary. The RFID tags may be mounted in other locations on the equipment, but preferably they are always mounted in the same relative position on each separate piece of equipment. For instance, The RFID tags may be on the right edge of the equipment. In fact, the RFID tag does not necessarily have to be on the front panel; Although mounting on the front panel makes retrofitting significantly easier. As will be described in more detail below, the strips 105 include at least the coil portion of an RFID interrogator. More particularly, the strips 105 are attached to the left-hand vertical rail 110 of the rack so that each interrogator coil is positioned immediately adjacent a slot of the rack. In some embodiments, the strips also may include some or all of the circuitry for conditioning the RFID tag signals. For instance, this may include amplifiers, filters, and/or resonance circuits.

Since the racks can be as tall as 8 feet or more and it may be unwieldy to manufacture, ship, install, and/or handle interrogator strips of such long lengths, the strips may be made modular in shorter lengths that can be connected in series on the racks. In one particular embodiment of the invention, each strip is approximately 1 foot long, comprising six coils 111 corresponding to six slots in the rack. Each strip 105 comprises a male connector 201 at one end and a female connector 203 at the other end so that the strips can be coupled in series in only one orientation. Each strip comprises an approximately 1 foot by approximately 1 inch PCB (printed circuit board) containing the aforementioned circuitry housed within a protective housing. In one preferred embodiment of the invention, the housing is plastic with magnets adhered to one side so that the strips can be mounted to the racks magnetically. This allows the system to be readily incorporated into conventional racks.

In order to cause each coil to excite and detect the RFID tag of only the piece of equipment located in the corresponding slot of the corresponding rack (and not RFID tags of other, nearby equipment, such as equipment in the adjacent slots of the rack or in the same slot of adjacent racks), the system uses low frequency energy to excite the interrogator coils 111 to generate a short range magnetic field rather than high-frequency electromagnetic energy to generate an electromagnetic field to excite RFID tag. Particularly, by using a relatively low frequency signal to energize the interrogator coils (less than 10 MHz) and, preferably, less than 1 MHz), the wavelength of the electromagnetic wave is very long. For instance, at 125 KHz, the electromagnetic wavelength, λ, is about 2400 meters long. In order for an antenna to efficiently radiate electromagnetic energy of a given wavelength, the antenna length should be a relatively small power-of-two fraction of the wavelength, such as λ, λ/2, λ/4, λ/8. In this system, the interrogator consists of a resonator that comprises a coil and a capacitor to generate the resonance. Thus, even a very large interrogator coil with many windings, would be a tiny fraction of the 2400 meter wavelength of a 125 KHz signal. Hence, the interrogator coil will not radiate low frequency electromagnetic energy of any significant power.

On the other hand, the interrogator coil essentially is an inductor. If placed in series with a capacitor of suitable capacitance value, it will have magnetic resonance at 125 kHz or any other frequency desired. Thus, the dominant energy that leaks out of the interrogator coil is the magnetic field of the coil. A miniscule electromagnetic field at 125 KHz may radiate, but it is negligible for the purpose of this system. Also, the power of a magnetic field attenuates at a rate of 1/r³, where r is distance, whereas electromagnetic fields attenuate at a rate of 1/r². Accordingly, a magnetic field drops off to negligible strength very quickly as distance from the antenna or coil increases, thus providing only very short-range RFID tag detection.

Accordingly, the interrogator coils of the system can be used to excite and read RFID tags that are only within a very small distance from the interrogator coil, e.g., about ¼ inch to about 4 inches depending on various parameters like power, coil diameter, ferrite properties, and the Q of the resonant circuit. Hence, this type of excitation is particularly suitable for use in a system for detecting the exact rack and slot of a piece of equipment where other equipment may be located within inches thereof.

The magnetic excitation and detection of RFID tags works just like the electromagnetic excitation described above. Particularly, when the interrogator coil 111 is excited with the 125 KHz drive signal, if an RFID tag 108 is sufficiently close to the interrogator coil 111 to magnetically couple to it, then the coil on the RFID tag 108 will draw power from the interrogator coil 111, which power draw can be detected by appropriate detection circuitry (e.g., an envelope detector). More particularly, the RFID tag will draw power in a specific pattern dictated by its unique ID code. The variations in the amplitude on the 125 KHz signal on the interrogator coil 111 can be analyzed to determine the unique identification code of the RFID tag that it is detecting. Specifically, for instance, the signal on the interrogator coil can be demodulated, filtered, amplified, and passed to a comparator to convert it to a binary signal corresponding to the specific identification code of that RFID tag.

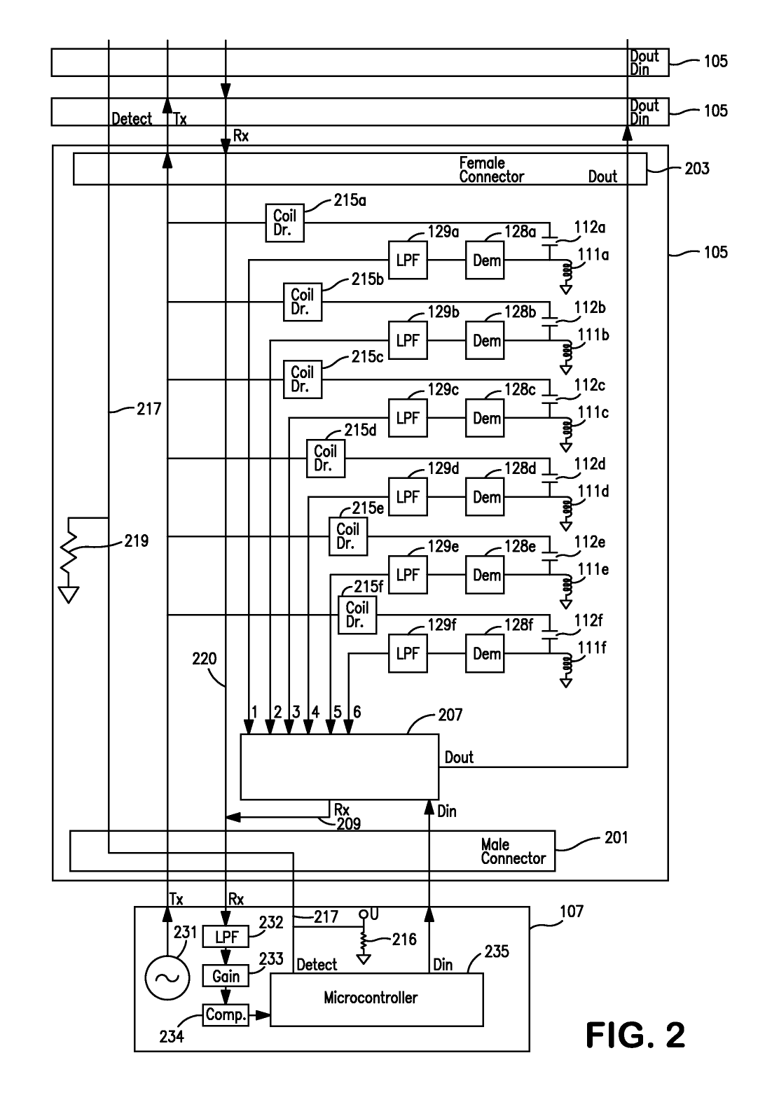

FIG. 2 is a block diagram showing the various components of a system for RFID tracking of equipment in a rack and slot system in accordance with one particular embodiment of the present invention.

In FIG. 2, all of the strips 105 are identical. Accordingly, the detail of the circuitry within the strips is illustrated for only one of the strips. As can be seen in FIG. 2, a plurality of strips 105 may be coupled in series via the aforementioned male and female connectors 201, 203 at opposite ends of the strips, respectively. The bottom-most strip 105 is coupled to the controller 107. The connection may be a wired connection or a wireless connection. In the illustrated embodiment, each strip comprises six interrogator resonator circuits, each comprising a capacitor and a coil pair 111a and 112a, 111b and 112b, 111c and 112c, 111d and 112d, 111e and 112e, and 111f and 112f. The coils 111a-111f may be EMI suppression ferrite coils. Each strip 105 also includes a multiplexer 207 having an input terminal coupled to the detection circuit of each coil 111a-111f and a single output terminal 209. Part of the envelope detection circuitry for each coil 111, such as a demodulator 128a-128f and/or a filter 129a-129f, is provided on the strip 105.

Although the illustrated embodiment shows a demodulator 128a-128f and filter 129a-129f associated with each coil 111a-111f, alternately, a single demodulator and/or filter can be provided between the output 209 of the multiplexer and the male connector 201. In yet another embodiment, no signal conditioning may be performed on the strip and the demodulation and filtering can be performed entirely in the control box 107. While the preferred embodiment employs passive circuitry for performing the envelope detection, active envelope detection could be employed also. Furthermore, the illustrated envelope detection scheme is merely one exemplary technique of converting the signal on the interrogator coils to binary form. Other techniques are well known and could be used in the alternative.

In the illustrated embodiment, each coil 111a-111f on an interrogator strip 103 also includes a coil driver circuit 215a-f, each having an input terminal coupled to a terminal on the male connector 201 for coupling to an oscillator 231 in the control box 107. Separate drivers help to isolate the coils from each other. The output terminal of each coil driver circuit 215a-f is coupled to the corresponding coil 111a-111f on the strip 105. The oscillator signal that is fed to the six coil drivers 215a-215f via the bottom connector 201 also is applied to the female connector 203 for forwarding to the antenna driver circuit 215 of any subsequent strips in the series connected strips. In addition, each strip 105 includes another uninterrupted conductor line 217 running between the male connector 201 and the female connector 203. However, a resistor 219 is coupled between line 217 and ground. This line is used by the microcontroller 235 to determine the number of strip modules connected in series to the microcontroller by detecting the total resistance on that line 217. Particularly, the lines 217 of all of the connected strips 105 are connected in series to the controller 107 through the connectors 201, 203. Inside the controller 107, the number of strips connected to the controller 107 can be determined by applying a known voltage, U, to a divider formed by another internal resistor 216 of the same value R and the parallel circuit of all resistors 219 that are connected to the controller via the conductor line 217. Measurement of the voltage at the input of the conductor line 217 to the microcontroller corresponds to the number of strips connected. For example, when there are no strips connected to the controller, the voltage on line 217 will be U. If one strip is connected, the voltage detected on line 217 by the microcontroller 235 will be U/2. With two strips 105 connected, the voltage will be 2 U/3. With 3 strips connected, the voltage will be 3 U/4, and so on.

In a preferred embodiment of the invention, in order to make of the strips easily modular and connectable in series, the multiplexer 207 is a serial cascadable multiplexer. For instance, one suitable serial cascadable multiplexer is the model LTC1391 multiplexer available from Linear Technology Corporation of Milpitas, Calif., United States. The serial cascadable multiplexers accept a serial control word at their Dᵢₙ terminals for controlling the multiplexer. Each multiplexer includes a series shift register that delays the control word and then shifts it out onto its Dₒᵤₜ terminal. The Dₒᵤₜ terminal of each multiplexer is coupled to the Dᵢₙ terminal of the multiplexer of the subsequent strip in the chain of strips through the female connector 203 of the strip and the male connector of the subsequent strip so that the control word supplied by the microcontroller sequentially controls the multiplexers on the series-connected strips.

The multiplexers are designed so that each multiplexer runs through its inputs to sequentially present them to the multiplexer output terminal and then the next multiplexer does the same thing. Hence, 12, 18, 24, or more multiplexed signals can be presented on the single Rx line 221 by simply serially cascading multiple multiplexers together. The outputs 219 of the multiplexers are coupled to a bus 220 that runs through the series connected strips and is coupled to a data input terminal of the microcontroller 235, as discussed below in more detail.

The use of serial cascadable multiplexers allows all of the multiplexers 207 in a chain of series-connected strips 105 to be controlled by the controller 107 with one control word. If conventional multiplexers were used, then the controller would need to generate a control word for each multiplexer and the controller and strips would need more lines to carry the extra control words. With the series cascadable multiplexers, only three control lines are needed to control the multiplexers, namely: (1) the clock line CLK; (2) Dᵢₙ, which is the serial multiplexer control word); and CS, which is the channel select line, which, in a first state, enables the multiplexer to read in the channel selection bits on Dᵢₙ and allows digital data transfer from Dᵢₙ to Dₒᵤₜ and, in a second state, places Dₒᵤₜ into three-state and enables the selected channel for analog signal transmission. Just one line is needed to read in the data from the coils.

Referring now to the circuit components in the controller box 107, controller 107 includes an oscillator 231 for providing a drive signal to the coils through the coil driver circuits 215a-215f on the interrogator strips 105. In addition, the signals from the various coils are received through the multiplexer output terminals on the receive line 220 and input to a low pass filter 232, an amplifier or gain circuit 233, and a comparator 234 before being input to the microcontroller 235. The microcontroller is exemplary and it should be understood by persons of skill in the related arts that the processing of the signals can be performed by any reasonable signal processing circuitry, including a microcontroller, a digital signal processor, an ASIC (Application Specific Integrated Circuit), a state machine, combinational logic, a computer, a general purpose computer, analog circuitry, etc, and/or any combinations thereof. In the illustrated exemplary embodiment, the low pass filter 232, gain circuit 233, and comparator 234, is merely an exemplary apparatus for converting the analog amplitude modulation signal into a binary signal by filtering out the 125 KHz carrier, amplifying the signal, and converting it into one of two predetermined voltage levels, as well known in the art. Various alternate techniques for achieving these functions are available and well-known in the art and require no explanation. Also, other techniques for decoding and processing the RFID signals could be implemented. The particular method and technique for decoding the RFID signals is not significant.

The microcontroller 235 then analyzes the information received consecutively from the various coils to determine whether a particular slot of the rack is occupied by a piece of equipment and, if so, its identification code. The microcontroller may forward this information to other computer equipment that will organize the data and display it or print it in a report. Alternately, the microcontroller may be designed to do this itself or may be replaced with a programmed general purpose computer that may perform such functions and/or generate such reports.

In addition, the microcontroller also generates the control word for controlling the serial cascadable multiplexers. Furthermore, as previously mentioned, the microcontroller receives the signal on the line 217 and analyzes the impedance on that line to determine how many strips are connected in series to the controller 107. Then, it can generate the control word to place on the Dᵢₙ line for controlling the multiplexers 207 based on the determined number of strips that are coupled in series to it.

The magnetic field is concentrated on the central axis of the coils and drops off rather quickly as one moves angularly away from the axis. Accordingly, in a preferred embodiment, the coils are oriented and the strips are mounted on the racks so that the central axes of the coils 111 point in the direction toward the RFID tags 108 of the equipment 104 mounted in the rack 101. This feature in conjunction with the use of magnetic coupling, as opposed to electromagnetic coupling, virtually guarantees that each antenna will only excite and/or read an RFID tag positioned in the slot immediately adjacent to the particular interrogation coil.

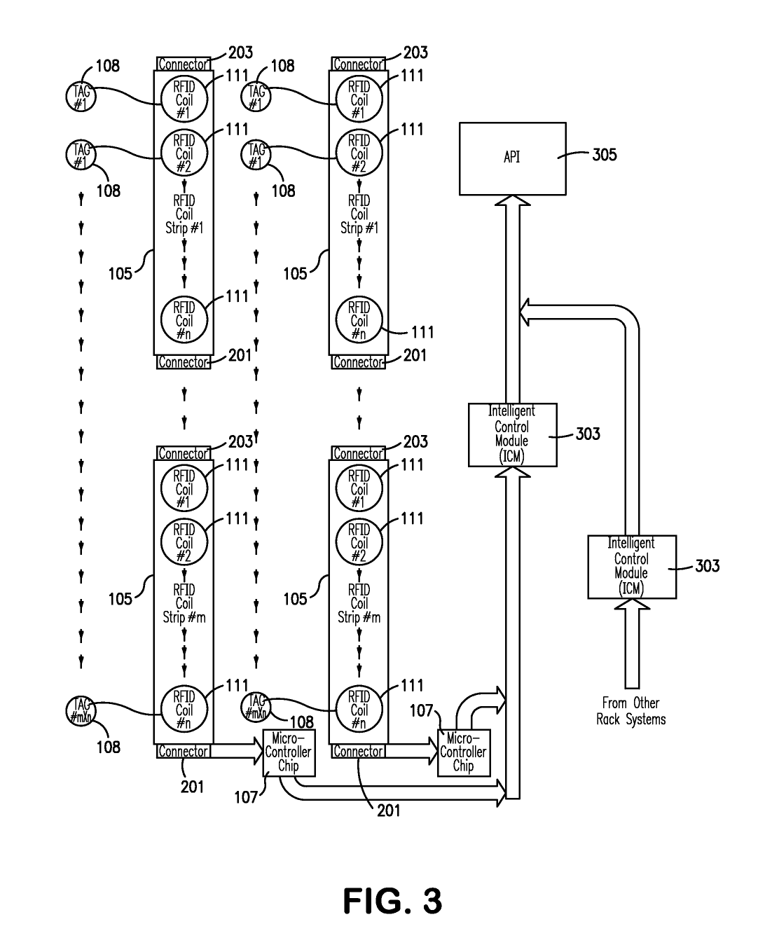

As previously noted, this invention may be useful in connection with data centers and other equipment rooms that may contain thousands of computer servers or other asset mounted in hundreds of racks or other closely spaced intervals. Accordingly, the system is made very flexible and scalable, as illustrated in FIG. 3. As shown therein, a plurality of strips 105 may be connected in series on a rack 101 with one controller 107 for each rack. There may be a plurality of such racks, and the controllers 107 for all of those racks may be coupled to an intelligent control module (ICM) 303 that monitors the plurality of controllers, organizes the oncoming data, and generates reports and other data for the entire room of racks. The ICM may be any reasonable computing device, including a microcontroller, a digital signal processor, an ASIC, a state machine, combinational logic, a computer, a general purpose computer, analog circuitry, etc, and/or any combinations thereof.

Furthermore or alternately, a plurality of intelligent control modules 303 may have their outputs further coupled to another computing device, such as through an API (Application Program Interface) 305 that collectively organizes, analyzes and/or processes the data, and/or generates equipment reports for multiple equipment rooms (or multiple buildings, for that matter). The various connections between the strips 105 and controllers 107, between the controllers 107 and ICMs 303, and between the ICMs 303 and API 305 may take any reasonable form, including wired or wireless, serial or parallel, etc.

While the invention has been described above in connection with a system specifically adapted for use with equipment racks, it should be understood that this is merely exemplary and that the invention is suitable for any environment in which RFID tagged items may be spaced very closely together. In other applications which the RFID tagged items will not be stored in vertical racks, the interrogator modules may take a completely different shape. While the invention has been described above in connection with an embodiment in which there is one microcontroller for each rack, one intelligent control module for each equipment room, and an API for multiple rooms, these embodiments are merely exemplary. In other embodiments, there may be two or more microcontrollers per rack or one microcontroller for two or more racks. The same flexibility exists in connection with the ICMs 303 and APIs 305.

Further, the figures do not necessarily illustrate all of the connections. For instance, there typically would need to be connectors between the strips 105 and the controller 107 at least for ground, a power supply, and a clock. However, such connections are not illustrated in order not to obfuscate the invention.

Having thus described a few particular embodiments of the invention, various alterations, modifications, and improvements will readily occur to those skilled in the art. Such alterations, modifications, and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

1. A system for detecting, in an equipment rack comprising a plurality of slots, the presence and specific slot of devices bearing a radio frequency identification (RFID) tag in the rack, the system comprising:
a plurality of resonator circuits, each resonator circuit corresponding to and disposed adjacent to a slot in the equipment rack;
a first circuit for driving the plurality of resonator circuits with a drive signal for exciting RFID tags via magnetic field excitation;
a multiplexer having a plurality of input terminals, each input terminal coupled to one of the plurality of resonator circuits, and an output terminal; and
a signal processing circuit coupled to the output terminal of the multiplexer for reading the signals of the resonator circuits and determining the identification of any RFID tags excited by the resonator circuits.

2. The system of claim 1 wherein the multiplexer is a serial cascadable multiplexer.

3. The system of claim 2 comprising a plurality of multiplexers, each multiplexer having a plurality of resonator circuits associated therewith, the plurality of multiplexers coupled in serial cascade to the signal processing circuit.

4. The system of claim 3 comprising a plurality of the signal processing circuits, each signal processing circuit having the output terminals of a plurality of the multiplexers coupled thereto and wherein the plurality of signal processing circuits are further coupled to an intelligent control module adapted to organize data from the coils, and signal processing circuits.

5. The system of claim 2 wherein the resonator circuits each comprise a coil, a capacitor, and at least a portion of an envelope detection circuit associated with each resonator circuit.

6. The system of claim 5 wherein each envelope detection circuit comprises a demodulator and a filter.

7. The system of claim 2 wherein the plurality of resonator circuits and the multiplexer are embodied on a strip mountable to the rack and wherein the signal processing circuit is separate from the strip.

8. The system of claim 7 wherein the strip comprises a plurality of strips, each strip having a first longitudinal end and a second longitudinal end and a first connector at the first longitudinal end and a second connector at the second longitudinal end, wherein the plurality of strips can be connected in series to each other and to the signal processing circuit via the first and second connectors.

9. The system of claim 8 wherein each strip further comprises a conductor coupled to the output terminal of the multiplexer and also coupled between the first and second connectors forming a bus through a plurality of strips connected in series.

10. The system of claim 7 wherein the signal processing circuit comprises a digital signal processing circuit and further comprises a filter, a gain circuit, a comparator coupled in series between the output terminal of the multiplexer and the microcontroller.

11. The system of claim 10 wherein the first circuit for driving the plurality of resonator circuits comprises an oscillator embodied unitarily with the signal processing circuit and a plurality of resonator drive circuits in each strip, each resonator drive circuit connected between the oscillator and a corresponding resonator circuit on that strip for generating the drive signal and driving the corresponding resonator circuit with the drive signal.

12. A modular system for detecting the presence and location of devices bearing a radio frequency identification (RFID) tag, the system comprising:
a plurality of interrogator modules, each interrogator module comprising a plurality of resonators, a serial cascadable multiplexer having a plurality of input terminals, each input terminal coupled to one of the plurality of resonators, and an output terminal, a first electrical connector and a second electrical connector for electrically coupling the plurality of modules in series with each other;
a first circuit for driving the plurality of resonators with a drive signal for exciting RFID tags via magnetic field excitation; and
a controller for coupling to the output terminals of the multiplexers of the series-connected strips adapted to read signals of the resonators and determine the identification of any RFID tags excited by the coils.

13. The system of claim 12 wherein the drive signal excites the RFID tags with magnetic field excitation.

14. The system of claim 13 further comprising at least a portion of an envelope detection circuit associated with each coil on each interrogator module.

15. The system of claim 13 wherein each envelope detection circuit comprises a demodulator and a filter associate with each coil and embodied on the module.

16. The system of claim 13 adapted for use in association with an equipment rack comprising a plurality of slots for mounting equipment for detecting the presence and specific slot of equipment bearing a radio frequency identification (RFID) tag wherein the interrogator modules comprise strips for mounting to an equipment rack, the strips having a longitudinal dimension, and wherein each resonator circuit comprises at least a coil, and wherein the coils are spaced longitudinally on the strip at intervals corresponding to the spacing of slots in a rack, and wherein the first electrical connector is disposed at a first longitudinal end of the strip and the second electrical connector is disposed at a second longitudinal end of the strip.

17. The system of claim 13 wherein the first circuit for driving the plurality of resonators comprises a driver circuit for each resonator circuit.

18. The system of claim 13 wherein each interrogator module further comprises a first conductor coupled to the output terminal of the multiplexer and also coupled between the first and second connectors forming a bus through a plurality of strips connected in series.

19. The system of claim 13 wherein each interrogator module further comprises a resistor having a first terminal coupled to ground and a second terminal, a second conductor coupled to the second terminal of the resistor and running between the first and second connectors forming a bus through a plurality of strips connected in series and further wherein the second conductor is coupled to circuitry for detecting the resistance on the second conductor and determining the number of modules connected in series as a function of the resistance.

20. A method of detecting the presence and location of devices bearing a radio frequency identification (RFID) tag, the method comprising:
providing a plurality of interrogator modules, each interrogator module comprising a plurality of resonator circuits, each resonator circuit including at least a coil, a serial cascadable multiplexer having a plurality of input terminals, each input terminal coupled to one of the plurality of resonator circuits, and an output terminal, a first electrical connector and a second electrical connector for electrically coupling the plurality of modules in series with each other;
driving the plurality of resonator circuits with a drive signal for exciting RFID tags; and
sequentially reading signals of the resonator circuits to determine the identification of any RFID tags excited by the coils.

21. The method of claim 20 wherein the driving comprises driving the resonator circuits with a drive signal that will excite the RFID tags with magnetic field excitation.
